(19) United States
(12) Patent Application Publication
(10) Pub. No.: US 2021/0198505 A1
(43) Pub. Date: Jul. 1, 2021

(54) Ink Jet Ink And Recording Apparatus

(71) Applicant: Seiko Epson Corporation, Toyko (JP)

(72) Inventors: Shunsuke UCHIZONO, Shiojiri (JP); Manabu TANIGUCHI, Shiojiri (JP); Soichi YAMAZAKI, Shiojiri (JP); Hiroaki KUMETA, Matsumoto (JP)

(21) Appl. No.: 17/132,451

(22) Filed: Dec. 23, 2020

(30) Foreign Application Priority Data
Dec. 26, 2019 (JP) 2019-235885

(51) Int. Cl. C09D 11/32; B41M 5/00

(52) U.S. Cl. CPC C09D 11/32; B41M 5/0023

(57) ABSTRACT

An ink jet ink contains an inorganic oxide colloid; a betaine; 1-(2-hydroxyethyl)-2-pyrrolidone; and water, and in the ink jet ink described above, a content of the betaine is equivalent to or larger than a content of a solid component of the inorganic oxide colloid on a mass basis.

The present application is based on, and claims priority from JP Application Serial Number 2019-235885, filed Dec. 26, 2019, the disclosure of which is hereby incorporated by reference herein in its entirety.

### BACKGROUND

### 1. Technical Field

The present disclosure relates to an ink jet ink and a recording apparatus.

### 2. Related Art

An ink jet recording method is able to record a highly fine image by a relatively simple apparatus and has been rapidly developed in various fields. Among the developments, various investigations on image quality and the like have been carried out. For example, in order to achieve a high print density, JP-A-2008-38090 has disclosed an ink jet-recording water dispersion which uses metal oxide secondary particles formed by connection between primary particles.

However, when an ink containing metal oxide secondary particles is used as disclosed in JP-A-2008-38090, nozzle clogging is liable to occur, and a problem may occur in some cases such that the clogging is not likely to be recovered even by performing a head cleaning operation. In addition, the ink disclosed in JP-A-2008-38090 is not an ink which can sufficiently suppress curling of a recorded matter to be obtained.

### SUMMARY

According to an aspect of the present disclosure, there is provided an ink jet ink containing: an inorganic oxide colloid; a betaine; 1-(2-hydroxyethyl)-2-pyrrolidone; and water, and in the ink jet ink described above, a content of the betaine is equivalent to or larger than a content of a solid component of the inorganic oxide colloid on a mass basis.

In addition, according to another aspect of the present disclosure, there is provided a recording apparatus comprising: an ink jet head having a nozzle which ejects the ink jet ink described above to a recording medium; and a transport device which transports the recording medium.

### BRIEF DESCRIPTION OF THE DRAWING

FIG. 1s a schematic cross-sectional view showing a recording apparatus according to this embodiment.

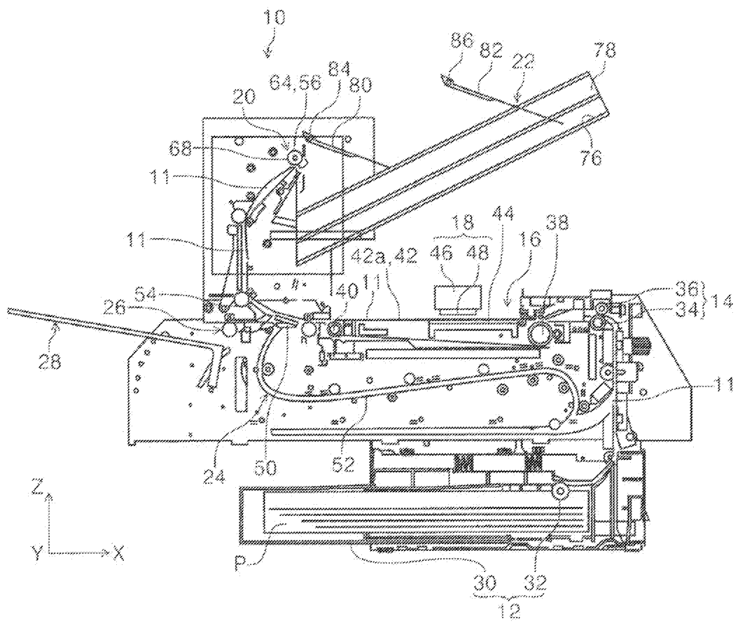

### DESCRIPTION OF EXEMPLARY EMBODIMENTS

Hereinafter, if needed, with reference to the drawing, although an embodiment (hereinafter, referred to as “this embodiment”) of the present disclosure will be described in detail, the present disclosure is not limited thereto and may be variously changed and/or modified without departing from the scope of the present disclosure. In addition, in the drawing, the same element is to be designated by the same reference numeral, and duplicated description will be omitted. In addition, unless otherwise particularly noted, a positional relationship, such as top-to-bottom or left-to-right, is based on a positional relationship shown in the drawing. Furthermore, a dimensional ratio in the drawing is not limited to the ratio shown in the drawing.

### 1. Ink Jet Ink

An ink jet ink (hereinafter, simply referred to as “ink” in some cases) according to this embodiment contains an inorganic oxide colloid, a betaine, 1-(2-hydroxyethyl)-2-pyrrolidone, and water, and the content of the betaine is equivalent to or larger than the content of a solid component of the inorganic oxide colloid on a mass basis.

When an ink containing an inorganic oxide colloid is used, an advantage can be obtained such that while a wet friction resistance of a printing surface is decreased, curling of a recorded matter to be obtained is suppressed. However, for example, when the ink is dried in the vicinity of a nozzle, a dispersion state of the inorganic oxide colloid is liable to change, and the inorganic oxide colloid is precipitated in the form of an aggregate, so that nozzle clogging is generated. Since the aggregate is tightly fixed to the nozzle, the clogging as described above is difficult to remove even by cleaning, and as a result, a problem of nozzle missing may occur in some cases.

In order to solve the problem of a clogging recovery property as described above, the use of a solvent, such as 2-pyrrolidone, having a high solubility is considered. However, when 2-pyrrolidone is used, by a function thereof, a problem in that curling becomes worse during drying of a printed matter may arise. Hence, by an ink jet ink according to a related technique, curling suppression and clogging recovery property of an ink jet head cannot be obtained at the same time.

On the other hand, according to the ink jet ink of this embodiment, since 1-(2-hydroxyethyl)-2-pyrrolidone is used, while a curling suppression effect by the inorganic oxide colloid is maintained, the clogging recovery property can also be obtained. Although not being clearly understood, the reason for this is believed that since 1-(2-hydroxyethyl)-2-pyrrolidone has a weak force to cut hydrogen bonds of a recording medium as compared to that of 2-pyrrolidone, curling is suppressed from being generated. In addition, since being able to promote re-dispersion of the inorganic oxide colloid, 1-(2-hydroxyethyl)-2-pyrrolidone is believed to contribute to the improvement in clogging recovery property.

Hereinafter, the components to be contained in the ink jet ink according to this embodiment, physical properties of the components, and a manufacturing method of the ink jet ink will be described.

### 1.1. Inorganic Oxide Colloid

The inorganic oxide colloid indicates a state in which particles, such as SiO₂, TiO₂, or Al₂O₃, are dispersed in a dispersion medium, and in this embodiment, the “ink containing an inorganic oxide colloid” indicates a state in which inorganic oxide particles are dispersed using a solvent which forms an ink as a dispersion medium.

Although the inorganic oxide colloid is not particularly limited, for example, a colloidal silica, a titanium oxide colloid, or an alumina colloid may be mentioned. Among those mentioned above, a colloidal silica is preferable. By using the inorganic oxide colloid as described above, curling of the recorded matter to be obtained is further suppressed, and as a result, a high speed transport of a recording medium can be performed. In addition, compared to a dry silica, such as a fumed silica, according to a colloidal silica, the precipitation is suppressed, and the dispersion stability tends to be further improved, and even when a colloidal silica is contained, since the viscosity of the ink jet ink is not likely to be increased, the ejection stability also tends to be improved. In addition, since the inorganic oxide colloid as described above is used, and the betaine and 1-(2-hydroxyethyl)-2-pyrrolidone are also used together therewith, the clogging recovery property tends to be further improved. In addition, the inorganic oxide colloid may be used alone, or at least two types thereof may be used in combination.

The particles of the inorganic oxide colloid may be surface-treated particles. For example, the colloidal silica may be surface-treated with alumina. Accordingly, a pH range in which the colloid can be stably dispersed is increased, and the dispersion stability tends to be further improved.

As the colloidal silica described above, a commercially available product may also be used, and for example, Snowtex 20, Snowtex 30, Snowtex 40, Snowtex O, Snowtex N, or Snowtex C (each manufactured by Nissan Chemical Corporation) may be mentioned.

An average particle diameter of the inorganic oxide colloid is preferably 5 to 100 nm, more preferably 5 to 80 nm, and further preferably 10 to 70 nm. Since the average particle diameter is 100 nm or less, the precipitation is suppressed, and the dispersion stability tends to be further improved. Since the average particle diameter of the inorganic oxide colloid is 5 nm or more, a sliding friction of a printing surface tends to be further improved.

The average particle diameter of the colloidal silica may be measured by a particle size distribution measurement device using a dynamic light scattering method as a measurement principle. As the particle size distribution measurement device described above, for example, there may be mentioned a “Zeta-potential/Particle size/Molecular weight measurement system ELSZ2000ZS” (trade name) which is manufactured by Otsuka Electronics Co., Ltd. and which uses a homodyne optical system as a frequency analysis method. In addition, in this specification, unless otherwise particularly noted, the “average particle diameter” indicates a number-basis average particle diameter.

The content of the inorganic oxide colloid as a solid component with respect to the total mass of the ink is preferably 1.0 to 15 percent by mass, more preferably 3.0 to percent by mass, and further preferably 4.0 to 8.0 percent by mass. Since the content of the inorganic oxide colloid is 1.0 percent by mass or more, curling of the recorded matter to be obtained is further suppressed, and hence, a transport speed of the recording medium can be further improved. In addition, since the content of the inorganic oxide colloid is 15 percent by mass or less, the clogging recovery property tends to be further improved.

The content of the solid component of the inorganic oxide colloid on a mass basis is preferably equivalent to or larger than the content of 1-(2-hydroxyethyl)-2-pyrrolidone (hereinafter, also referred to as “HE2P” in some cases). In particular, the content of the solid component of the inorganic oxide colloid with respect to the content of HE2P on a mass basis is preferably 1.0 to 12 times, more preferably 1.2 to 10 times, and further preferably 1.4 to 7.0 times. Since the content of the inorganic oxide colloid is in the range described above, curling of the recorded matter to be obtained is further suppressed, and the clogging recovery property tends to be further improved.

When an organic amine which will be described later is contained, the content of the solid component of the inorganic oxide colloid on a mass basis is preferably equivalent to or larger than the content of the organic amine. In particular, the content of the solid component of the inorganic oxide colloid with respect to the content of the organic amine on a mass basis is preferably 2.0 to 20 times, more preferably 3.0 to 17 times, and further preferably 4.0 to 15 times. Since the content of the inorganic oxide colloid is in the range described above, curling of the recorded matter to be obtained is further suppressed, and the clogging recovery property tends to be further improved.

### 1.2. Betaine

The betaine according to this embodiment indicates a compound which has a positive charge and a negative charge at positions not adjacent to each other in the same molecule and which has no charge as a whole molecule. A positive charge portion is preferably a quaternary ammonium cation. Although the betaine as described above is not particularly limited, for example, there may be mentioned trimethyl glycine, γ-butyrobetaine, homarine, trigonelline, carnitine, homoserine betaine, valine betaine, lysine betaine, ornithine betaine, alanine betaine, stachydrine, or betaine glutamate. Among those mentioned above, trimethyl glycine or γ-butyrobetaine is preferable, and trimethyl glycine is more preferable. When the betaine as described above is used, the clogging recovery property tends to be further improved. In addition, the betaine may be used alone, or at least two types thereof may be used in combination.

The number of carbon atoms forming the betaine is preferably 4 to 12, more preferably 4 to 7, and further preferably 4 to 6. Since the number of carbon atoms of the betaine is in the range described above, the stability against disturbance, such as intrusion of charged foreign materials, tends to be further improved.

The content of the betaine with respect to the total mass of the ink is preferably 1 to 25 percent by mass, more preferably 3 to 20 percent by mass, and further preferably 4 to 15 percent by mass. Since the content of the betaine is in the range described above, when the inorganic oxide colloid is aggregated by drying, a hard aggregate is suppressed from being formed, and in addition, since the dispersion stability of the inorganic oxide colloid is improved, the clogging recovery property tends to be further improved.

The content of the betaine is equivalent to or larger than the content of the solid component of the inorganic oxide colloid on a mass basis. In particular, the content of the betaine with respect to the content of the solid component of the inorganic oxide colloid is, on a mass basis, preferably 1.0 to 5.0 times, more preferably 1.0 to 3.0 times, and further preferably 1.2 to 2.5 times. Since the content of the betaine is in the range described above, curling of the recorded matter to be obtained is further suppressed, and the clogging recovery property tends to be further improved.

### 1.3. 1-(2-hydroxyethyl)-2-pyrrolidone

Since the ink of this embodiment uses 1-(2-hydroxyethyl)-2-pyrrolidone, curling of the recorded matter to be obtained is further suppressed, and the clogging recovery property tends to be further improved. The content of 1-(2-hydroxyethyl)-2-pyrrolidone with respect to the total mass of the ink is preferably 0.1 to 8.0 percent by mass, more preferably 0.5 to 6.0 percent by mass, and further preferably 0.7 to 4.0 percent by mass. Since the content of HE2P is in the range described above, curling of the recorded matter to be obtained tends to be further suppressed.

In addition, in the ink of this embodiment, as described above, instead of using a solvent, such as 2-pyrollidone, 1-(2-hydroxyethyl)-2-pyrrolidone is used. In view of the point as described above, the content of 2-pyrrolidone in the ink of this embodiment is preferably 0 to 0.5 percent by mass, more preferably 0 to 0.3 percent by mass, further preferably 0 to 0.1 percent by mass, and particularly preferably 0 percent by mass or a detectable level or less. Accordingly, curling of the recorded matter to be obtained tends to be further suppressed.

### 1.4. Water

The content of the water with respect to the total mass of the ink is preferably 40 to 80 percent by mass, more preferably 50 to 80 percent by mass, and further preferably 55 to 75 percent by mass. Since the content of the water is 40 percent by mass or more, even when the water is partially evaporated, an increase in viscosity of the ink is suppressed, and the ejection stability tends to be further improved. In addition, since the content of the water is 80 percent by mass or less, curling and/or cockling of the recorded matter to be obtained tends to be further suppressed.

### 1.5. Organic Amine

The ink jet ink of this embodiment may further contain an organic amine. Although the organic amine is not particularly limited, for example, there may be mentioned triethanolamine, diethanolamine, monoethanolamine, tripropanolamine, or triisopropanolamine. Among those mentioned above, triethanolamine or triisopropanolamine is preferable. Those organic amines are each able to function as a buffer agent which improves the stability of the inorganic oxide colloid. Hence, by the use of the organic amine as described above, the clogging recovery property tends to be further improved.

The content of the organic amine with respect to the total mass of the ink is preferably 0.1 to 5.0 percent by mass, more preferably 0.2 to 4.0 percent by mass, and further preferably 0.3 to 3.0 percent by mass. Since the content of the organic amine is in the range described above, the dispersion stability of the inorganic oxide colloid is further improved, and as a result, the clogging recovery property tends to be further improved.

### 1.6. Pigment

The ink jet ink of this embodiment may contain a pigment as a colorant. Although the pigment is not particularly limited, for example, there may be mentioned an azo pigment (such as an azo lake, an insoluble azo pigment, a condensed azo pigment, or a chelate azo pigment); a polycyclic pigment (such as a phthalocyanine pigment, a perylene pigment, a perynone pigment, an anthraquinone pigment, a quinacridone pigment, a dioxazine pigment, a thioindigo pigment, an isoindolinone pigment, or a quinophthalone pigment); an organic pigment, such as a nitro pigment, a nitroso pigment, or an aniline black; a carbon black (such as a furnace black, a thermal lamp black, an acetylene black, or a channel black); an inorganic pigment, such as a metal oxide, a metal sulfide, or a metal chloride; or an extender pigment, such as calcium carbonate or a talc.

The pigment described above is preferably added to the ink in the form of a pigment dispersion liquid which is selected from the group consisting of a pigment dispersion liquid formed by dispersing a pigment in water with a dispersant; a pigment dispersion liquid formed by dispersing a self-dispersible surface-treated pigment in water, the self-dispersible surface-treated pigment being formed by introducing hydrophilic groups on pigment particle surfaces using a chemical reaction; and a pigment dispersion liquid formed by dispersing a pigment covered with a polymer in water.

The pigment and the dispersant which form the pigment dispersion liquid described above each may be used alone, or at least two types thereof may be used in combination.

The content of the pigment as a solid component with respect to the total mass of the ink is preferably 1.0 to 12 percent by mass, more preferably 2.0 to 10 percent by mass, and further preferably 3.0 to 7.5 percent by mass.

### 1.7. Surfactant

The ink jet ink of this embodiment may contain a surfactant. Although the surfactant is not particularly limited, for example, there may be mentioned an acetylene glycol surfactant, a fluorine surfactant, or a silicone surfactant. Among those mentioned above, in view of the clogging recovery property, an acetylene glycol surfactant is preferable.

Although the acetylene glycol surfactant is not particularly limited, for example, at least one selected from the group consisting of 2,4,7,9-tetramethyl-5-decyne-4,7-diol, an alkylene oxide adduct thereof, 2,4-dimethyl-5-decyne-4-ol, and an alkylene oxide adduct thereof is preferable. Although a commercially available product of the acetylene glycol surfactant is not particularly limited, for example, there may be mentioned an Olfine 104 series or an E series such as Olfine E1010 (product name, manufactured by Air Products and Chemicals Inc.), or Surfynol 61, 104, or 465 (product name, manufactured by Nisshin Chemical Industry Co., Ltd.). The acetylene glycol surfactant may be used alone, or at least two types thereof may be used in combination.

Although the fluorine surfactant is not particularly limited, for example, there may be mentioned a perfluoroalkyl sulfonate salt, a perfluoroalkyl carboxylate salt, a perfluoroalkyl phosphate ester, a perfluoroalkyl ethylene oxide adduct, a perfluoroalkyl betaine, or a perfluoroalkylamine oxide compound. Although a commercially available product of the fluorine surfactant is not particularly limited, for example, there may be mentioned 5-144 or S-145 (manufactured by Asahi Glass Co., Ltd.); FC-170C, FC-430, or Fluorad FC4430 (manufactured by Sumitomo 3M Limited); FSO, FSO-100, FSN, FSN-100, or FS-300 (manufactured by Du Pont); or FT-250 or 251 (manufactured by Neos Co., Ltd.). The fluorine surfactant may be used alone, or at least two types thereof may be used in combination.

As the silicone surfactant, for example, there may be mentioned a polysiloxane compound or a polyether-modified organosiloxane. Although a commercially available product of the silicone surfactant is not specifically limited, in particular, for example, there may be mentioned BYK-306, BYK-307, BYK-333, BYK-341, BYK-345, BYK-346, BYK-347, BYK-348, or BYK-349 (trade name, manufactured by BYK Japan KK), or KF-351A, KF-352A, KF-353, KF-354L, KF-355A, KF-615A, KF-945, KF-640, KF-642, KF-643, KF-6020, X-22-4515, KF-6011, KF-6012, KF-6015, or KF-6017 (trade name, manufactured by Shin-Etsu Chemical Co., Ltd.).

The content of the surfactant with respect to the total mass of the ink is preferably 0.1 to 5.0 percent by mass and more preferably 0.1 to 3.0 percent by mass. Since the content of the surfactant is in the range described above, the clogging recovery property tends to be further improved.

### 1.8. Water-Soluble Organic Solvent

The ink jet ink of this embodiment may contain, besides the components described above, a water-soluble organic solvent. Although the water-soluble organic solvent is not particularly limited, for example, there may be mentioned glycerin, N-methylpyrrolidone, ethylene glycol, diethylene glycol, triethylene glycol, propylene glycol, dipropylene glycol, tripropylene glycol, propanediol, butanediol, pentanediol, or hexylene glycol. Among those mentioned above, in view of a moisturizing effect, glycerin is preferable.

The content of the water-soluble organic solvent with respect to the total mass of the ink is preferably 0.5 to 25 percent by mass, more preferably 3.0 to 20 percent by mass, and further preferably 5.0 to 15 percent by mass.

### 1.9. Method for Manufacturing Ink Jet Ink

A method for manufacturing the ink jet ink of this embodiment is not particularly limited, and for example, a method in which the inorganic oxide colloid, the betaine, 1-(2-hydroxyethyl)-2-pyrrolidone, and water are mixed together with, if needed, other components may be mentioned. In addition, the inorganic oxide colloid may be mixed in a colloid solution state, or when the pigment is used, the inorganic oxide colloid may be mixed in the state of a pigment dispersion liquid.

### 2. Ink Jet Method

An ink jet method according to this embodiment includes an ejection step of ejecting the ink jet ink described above onto a recording medium using a predetermined ink jet head and a transport step of transporting the recording medium to which the ink is adhered. In addition, the ejection step and the transport step may be simultaneously or alternately performed.

### 2.1. Ejection Step

In the ejection step, the ink is ejected from the ink jet head and is adhered to the recording medium. In more particular, a pressure generation device provided in the ink jet head is driven to eject the ink filled in a pressure generation chamber of the ink jet head from a nozzle. The ejection method as described above is also called an ink jet method.

As the ink jet head used in the ejection step, a line head which performs recording by a line method and a serial head which performs recording by a serial method may be mentioned.

In the line method using a line head, for example, an ink jet head having a width equivalent to or larger than a recording width of the recording medium is fixed to a recording apparatus. In addition, the recording medium is transferred along a sub-scanning direction (transport direction of the recording medium), and in association with this transfer, ink droplets are ejected from nozzles of the ink jet head, so that an image is recorded on the recording medium.

In the serial method using a serial head, for example, the ink jet head is mounted on a carriage configured to be transferred in a width direction of the recording medium. In addition, the carriage is transferred along a main scanning direction (width direction of the recording medium), and in association with this transfer, ink droplets are ejected from nozzles of the ink jet head, so that an image is recorded on the recording medium.

### 2.2. Transport Step

In the transport step, the recording medium is transported in a predetermined direction in the recording apparatus. In more particular, by the use of a transport roller and/or a transport belt provided in the recording apparatus, the recording medium is transported from a paper supply portion to a paper discharge portion of the recording apparatus. During the transport step described above, the ink ejected from the ink jet head is adhered to the recording medium, so that a recorded matter is formed. The transport may be continuously or intermittently performed.

### 2.3. Recording Medium

Although the recording medium used in this embodiment is not particularly limited, for example, an absorptive or a non-absorptive recording medium may be mentioned. Among those mentioned above, an absorptive recording medium is liable to cause a problem, such as curling; hence, the present disclosure is useful since the clogging recovery property is excellent although the inorganic oxide colloid is used.

Although the absorptive recording medium is not particularly limited, for example, regular paper, such as electrophotographic paper, and ink jet paper (ink jet exclusive paper including an ink absorbing layer formed from silica particles or alumina particles or an ink absorbing layer formed from a hydrophilic polymer, such as a poly(vinyl alcohol) (PVA) or a poly(vinyl pyrrolidone) (PVP)) each having a high ink permeability may be mentioned, and in addition, for example, art paper, coated paper, and cast paper, which have a relatively low ink permeability and which are used for general offset printing, may also be mentioned.

Although the non-absorptive recording medium is not particularly limited, for example, as the recording medium, there may be mentioned a film or a plate of a plastic, such as a poly(vinyl chloride), a polyethylene, a polypropylene, a poly(ethylene terephthalate) (PET), a polycarbonate, a polystyrene, or a polyurethane; a plate of a metal, such as iron, silver, copper, or aluminum; a metal plate or a plastic film, each of which is manufactured by deposition of at least one metal mentioned above; a plate of an alloy, such as stainless steel or brass; or a paper-made base material to which a film of a plastic, such as a poly(vinyl chloride), a polyethylene, a polypropylene, a PET, a polycarbonate, a polystyrene, or a polyurethane, is adhered (coated).

### 3. Recording Apparatus

A recording apparatus of this embodiment includes an ink jet head having a nozzle which ejects an ink jet ink to a recording medium and a transport device which transports the recording medium. The ink jet head includes a pressure chamber to which the ink is supplied and the nozzle which ejects the ink. In addition, the transport device is formed of a transport roller and/or a transport belt provided in the recording apparatus.

Hereinafter, the recording apparatus according to this embodiment will be described with reference to FIGURE. In addition, in an X-Y-Z coordinate system shown in FIGURE, an X direction indicates a length direction of the recording medium, a Y direction indicates a width direction of the recording medium in a transport path in the recording apparatus, and a Z direction indicates an apparatus height direction.

As one example of a recording apparatus 10, a line type ink jet printer capable of performing high-speed and high-density printing will be described. The recording apparatus 10 includes a supply portion 12 receiving a recording medium P, such as paper, a transport portion 14, a belt transport portion 16, a recording portion 18, an Fd (face-down) discharge portion 20 functioning as a “discharge portion”, an Fd (face-down) stage portion 22 functioning as a “stage portion”, a reverse path portion 24 functioning as a “reverse transport mechanism”, an Fu (face-up) discharge portion 26, and an Fu(face-up) stage portion 28.

The supply portion 12 is provided at a lower side of the recording apparatus 10. The supply portion 12 includes a supply tray 30 which receives the recording medium P and a supply roller 32 which supplies the recording medium P received in the supply tray 30 to a transport path 11.

The recording medium P received in the supply tray is supplied to the transport portion 14 along the transport path 11 by the supply roller 32. The transport portion 14 includes a transport drive roller 34 and a transport driven roller 36. The transport drive roller 34 is rotary driven by a drive source not shown. In the transport portion 14, the recording medium P is nipped between the transport drive roller 34 and the transport driven roller 36 and is then transported to the belt transport portion 16 located downstream in the transport path 11.

The belt transport portion 16 includes a first roller 38 located upstream in the transport path 11, a second roller 40 located downstream therein, an endless belt rotatably provided around the first roller 38 and the second roller 40, and a support body 44 which supports an upper-side region 42a of the endless belt 42 between the first roller 38 and the second roller 40.

The endless belt 42 is driven by the first roller 38 or the second roller 40 which is driven by a drive source not shown so as to be transferred from a +X direction to a −X direction in the upper-side region 42a. Hence, the recording medium P transported from the transport portion 14 is further transported downstream in the transport path 11 by the belt transport portion 16.

The recording portion 18 includes a line type ink jet head 48 and a head holder 46 which holds this ink jet head 48. In addition, the recording portion 18 may also be a serial type in which an ink jet head is provided on a carriage configured to be reciprocally transferred in a Y axis direction. The ink jet head 48 is disposed to face the upper-side region 42a of the endless belt 42 supported by the support body 44. When the recording medium P is transported in the upper-side region 42a of the endless belt 42, the ink jet head 48 ejects the ink to the recording medium P, so that recording is performed. While recording is performed, the recording medium P is transported downstream in the transport path 11 by the belt transport portion 16.

In addition, the “line type ink jet head” is a head in which a nozzle region formed in a direction to intersect a transport direction of the recording medium P is provided to cover the entire intersection direction of the recording medium P, and this head is used in a recording apparatus in which one of the head and the recording medium P is fixed, and the other is transferred to form an image. In addition, the nozzle region of the line head in the intersection direction may not be required to cover the entire intersection direction of every recording medium P which is to be used in the recording apparatus.

In addition, a first branch portion 50 is provided downstream in the transport path 11 of the belt transport portion 16. The first branch portion 50 is configured to switch between the transport path 11 which transports the recording medium P to the Fd discharge portion 20 or to the Fu discharge portion 26 and a reverse path 52 of the reverse path portion 24 which reverses a recording surface of the recording medium P and again transports the recording medium P to the recording portion 18. In addition, in the recording medium P which is transported to the reverse path by switching of the first branch portion 50, the recording surface is reversed in a transport step in the reverse path 52, and a surface opposite to the original recording surface is again transported to the recording portion 18 so as to face the ink jet head 48.

A second branch portion 54 is further provided downstream of the first branch portion 50 along the transport path 11. The second branch portion 54 is configured to switch a transport direction of the recording medium P so that the recording medium P is transported to the Fd discharge portion 20 or to the Fu discharge portion 26.

The recording medium P transported to the Fd discharge portion 20 by the second branch portion 54 is discharged from the Fd discharge portion 20 and is placed on the Fd stage portion 22. In this step, the recording surface of the recording medium P is placed so as to face the Fd stage portion 22. In addition, the recording medium P transported to the Fu discharge portion 26 by the second branch portion 54 is discharged from the Fu discharge portion 26 and is placed on the Fu stage portion 28. In this step, the recording surface of the recording medium P is placed so as to face a side opposite to the Fu stage portion 28.

In a recording apparatus using an ink jet method, since an ink which is a liquid is adhered to a recording medium, for example, a problem, such as curling, may occur in a recording medium, in particular, in an absorptive recording medium, such as regular paper or ink jet paper, and in addition, a problem in that since being discharged and stacked before the ink is dried, recorded matters cannot be accurately stacked to each other may also occur. In particular, when the recording medium is transported at a high speed of 0.5 m/s or more, the problems described above tend to be serious. In addition, in the case of a solid image having a high wet friction resistance on an ink jet printing surface, the recorded matters are not smoothly slid and are jammed to each other, or although being approximately stacked to each other, the recorded matters cannot be accurately aligned to each other; hence, a problem in that the recorded matters cannot be stapled at the accurate positions may occur in some cases. In addition, in a face-down paper discharge in which paper is discharged while a printing surface thereof faces downward, since the ink is difficult to dry, a problem in that a stacking property is difficult to obtain may arise in some cases. In addition, since a printing surface of an absorptive recording medium is swelled when printing is performed thereon, paper discharge curling (primary curling) in which the printing surface forms a convex shape right after the printing is also disadvantageously generated. Furthermore, when the drying is advanced, since the printing surface is contracted, permanent curling (secondary curling) in which the printing surface forms a concave shape within ten and several seconds to several minutes is disadvantageously generated.

On the other hand, in this embodiment, since the ink jet ink containing an inorganic oxide colloid is used, while the wet friction resistance of the printing surface is decreased, the curling can be suppressed, so that the stacking property can be improved. In particular, when ink jet recording is performed while the recording medium P is transported at a high speed of 0.5 m/s or more, an effect of improving the stacking property becomes significant.

In addition, although the case in which the line type ink jet head is used is described by way of example, the recording apparatus according to this embodiment may be a printer (serial printer) using a serial type ink jet head. In the serial printer, while a recording medium is transported in a transport direction, the ink jet head is transferred in a direction intersecting the transport direction to perform printing. Even by the serial printer, when a relative speed between the head and the recording medium during the printing is high, such as 0.5 m/s or more, a problem of the stacking property is generated; hence, by the use of the ink described above, the effect of improving the stacking property can be obtained.

### Examples

Hereinafter, the present disclosure will be described in more detail with reference to examples and comparative examples. However, the present disclosure is not limited to the following examples.

### 1. Preparation of Ink

After components were charged in a mixture tank so as to have a composition shown in Table 1 and were then mixed and stirred, filtration using a 5-μm membrane filter was performed, so that an ink jet ink of each example was obtained. In addition, unless otherwise particularly noted, the numerical value of each component shown in each example of the table represents percent by mass. In addition, in the table, the numerical values of an inorganic oxide colloid and a pigment dispersion liquid each represent percent by mass of a solid component.

TABLE 1

| | | EXAMPLE | | | | | COMPARATIVE EXAMPLE | | | | |
|---|---|---|---|---|---|---|---|---|---|---|---|
| | | 1 | 2 | 3 | 4 | 5 | 1 | 2 | 3 | 4 | 5 |
| INORGANIC | COLLOIDAL | | | 5.0 | | | 5.0 | 5.0 | | | |
| OXIDE | SILICA PARTICLE | | | | | | | | | | |
| COLLOID | DIAMETER: 20 nm | | | | | | | | | | |
| | COLLOIDAL | 5.0 | 5.0 | | | 7.0 | | | 7.0 | 11.0 | |
| | SILICA PARTICLE | | | | | | | | | | |
| | DIAMETER: 45 nm | | | | | | | | | | |
| | TITANIUM OXIDE | | | | 5.0 | | | | | | |
| | COLLOID PARTICLE | | | | | | | | | | |
| | DIAMETER: 20 nm | | | | | | | | | | |
| PIGMENT | Aqua-Black | 7.0 | 7.0 | 7.0 | 7.0 | 7.0 | 7.0 | 7.0 | 7.0 | 7.0 | 7.0 |
| DISPERSION | | | | | | | | | | | |
| LIQUID | | | | | | | | | | | |
| SURFACTANT | OLFINE E1010 | 0.5 | 0.5 | 0.5 | 0.5 | 0.5 | 0.5 | 0.5 | 0.5 | 0.5 | 0.5 |
| | SURFYNOL 104 | 0.5 | 0.5 | 0.5 | 0.5 | 0.5 | 0.5 | 0.5 | 0.5 | 0.5 | 0.5 |
| NITROGEN- | HE2P | 3.0 | 3.0 | 1.0 | 1.0 | 3.0 | | 7.0 | | 1.0 | 5.0 |
| CONTAINING | 2-PYRROLIDONE | | | | | | 5.0 | | | | |
| COMPOUND | | | | | | | | | | | |
| BETAINE | TRIMETHYL GLYCINE | 8.0 | | 8.0 | 8.0 | 7.0 | 5.0 | | 8.0 | 8.0 | 8.0 |
| | γ-BUTYROBETAINE | | 8.0 | | | | | | | | |
| ORGANIC AMINE | TRIETHANOLAMINE | 1.0 | 0.5 | 1.0 | 0.5 | 0.5 | 0.5 | 0.5 | 0.5 | 0.5 | 1.0 |
| WATER | | BAL- | BAL- | BAL- | BAL- | BAL- | BAL- | BAL- | BAL- | BAL- | BAL- |
| | | ANCE | ANCE | ANCE | ANCE | ANCE | ANCE | ANCE | ANCE | ANCE | ANCE |
| RESULT | CURLING | A | B | A | B | A | C | C | A | A | C |
| | CLOGGING | | | | | | | | | | |
| | RECOVERY | | | | | | | | | | |
| | PROPERTY | A | A | A | A | A | A | B | C | C | A |

Abbreviations and product components used in Table 1 are as follows.

### Pigment Dispersion Liquid

Pigment Aqua-Black (manufactured by Tokai Carbon Co., Ltd.)

### Inorganic Oxide Colloid

Colloidal silica (manufactured by Nissan Chemical Corporation, ST-CM, particle diameter: 20 nm, solid component: 30%)

Colloidal silica (manufactured by Nissan Chemical Corporation, ST-30L, particle diameter: 45 nm, solid component: 30%)

Titanium oxide colloid (manufactured by Tayca Corporation, trade name: MT-100WP, particle diameter: 20 nm)

### Surfactant

Olfine E1010 (trade name, manufactured by Air Products and Chemicals Inc., acetylene glycol surfactant)

Surfynol 104 (trade name, manufactured by Nisshin Chemical Industry Co., Ltd., acetylene glycol surfactant)

### Nitrogen-Containing Compound

1-(2-hydroxyethyl)-2-pyrrolidone (HE2P)

2-pyrrolidone

### Betaine

Trimethyl glycine (betaine anhydrous, manufactured by Tokyo Chemical Industry Co., Ltd.)

γ-butyrobetaine

### Organic Amine

Triethanolamine

### 2. Evaluation Method

### 2.1. Evaluation of Curling

The ink was filled in an ink cartridge of a PX-S840 (serial jet printer) manufactured by EPSON, and a solid pattern having a duty of 100% was printed in an environment at a temperature of 25° C. and a humidity of 50% on a recording medium (A4-size Xerox P paper, copy paper manufactured by Fuji Xerox Co., Ltd., basis weight: 64 g/m², paper thickness: 88 μm). Subsequently, after the copy paper thus printed was left for one week while the solid pattern was allowed to face upward, a lifting distance of a paper edge from a floor surface was measured. The evaluation criteria are as described below.

Evaluation Criteria

A: lifting distance of less than 10 mm
B: lifting distance of 10 to less than 20 mm
C: lifting distance of 20 mm or more

### 2.2. Evaluation of Clogging Recovery Property

The ink was filled in an ink cartridge of a PX-5840 (serial ink jet printer) manufactured by EPSON, and all nozzles were confirmed to eject the ink. Subsequently, in the state in which an ink jet head was shifted from a position of a cap provided in the printer and was not capped, the ink jet head was left for 7 days in an environment at a temperature of 40° C. and a humidity of 20%.

After the ink jet head was left as described above, as cleaning of the ink jet head, a suction operation of the ink in the nozzle was performed. After each suction operation, the number of nozzles which were not able to eject the ink was counted, and the cleaning operation was repeatedly performed until all the nozzles were recovered. In addition, based on the number of cleaning operations at which all the nozzles were recovered, the clogging recovery property was evaluated in accordance with the following criteria. The results are shown in Table 1.

Evaluation Criteria

A: The number of cleaning operations is less than 3 times.

B: The number of cleaning operations is 3 to less than 6 times.

C: The number of cleaning operations is 6 or more.

### 3. Evaluation Result

In Table 1, the composition of the ink used in each example and the evaluation result thereof are shown. From Table 1, it is found that when an ink containing an inorganic oxide colloid, a betaine, and 1-(2-hydroxyethyl)-2-pyrrolidone is used, and when the content of the betaine is equivalent to or larger than the content of the solid component of the inorganic oxide colloid on a mass basis, curling of a recorded matter to be obtained is further suppressed, and even by the ink containing an inorganic oxide colloid, an excellent clogging recovery property is obtained.

In particular, when each example is compared to Comparative Example 1, it is found that since HE2P is used instead of using 2-pyrrolidone, curling of the recorded matter to be obtained is suppressed. In addition, when each example is compared to Comparative Example 2, it is found that since the betaine is used, curling of the recorded matter to be obtained is suppressed, and the clogging recovery property is further improved. Furthermore, when each example is compared to Comparative Example 3, it is found that since HE2P is used, the clogging recovery property is further improved. In addition, when each example is compared to Comparative Example 4, it is found that since the content of the betaine is set to be equivalent to or larger than the content of the solid component of the inorganic oxide colloid, the clogging recovery property is further improved. Furthermore, when each example is compared to Comparative Example 5, it is found that since the inorganic oxide colloid is used, curling of the recorded matter to be obtained is suppressed.

In addition, after the ink of each example was filled in an ink cartridge of an LX-10000F (line jet printer) manufactured by EPSON, when a solid pattern having a duty of 100% was continuously printed in an environment at a temperature of 25° C. and a humidity of 50% on 20 recording media (A4-size Xerox P paper, copy paper manufactured by Fuji Xerox Co., Ltd., basis weight: 64 g/m², paper thickness: 88 μm), and the recording media were discharged so as to face downward, the recording media were preferably stacked to each other.

What is claimed is:

1. An ink jet ink containing:
an inorganic oxide colloid;
a betaine;
1-(2-hydroxyethyl)-2-pyrrolidone; and
water,
wherein a content of the betaine is equivalent to or larger than a content of a solid component of the inorganic oxide colloid on a mass basis.

2. The ink jet ink according to claim 1,
wherein the inorganic oxide colloid includes a colloidal silica.

3. The ink jet ink according to claim 1,
wherein the inorganic oxide colloid has an average particle diameter of 10 to 70 nm.

4. The ink jet ink according to claim 1,
wherein the content of the inorganic oxide colloid as the solid component is 3.0 to 10 percent by mass with respect to a total mass of the ink.

5. The ink jet ink according to claim 1, further containing an organic amine.

6. The ink jet ink according to claim 5,
wherein the organic amine includes triethanolamine or triisopropanolamine.

7. The ink jet ink according to claim 5,
wherein a content of the organic amine is 0.1 to 5.0 percent by mass with respect to a total mass of the ink.

8. The ink jet ink according to claim 5,
wherein the content of the solid component of the inorganic oxide colloid is equivalent to or larger than a content of the organic amine on a mass basis.

9. The ink jet ink according to claim 1,
wherein the content of the solid component of the inorganic oxide colloid is equivalent to or larger than a content of 1-(2-hydroxyethyl)-2-pyrrolidone on a mass basis.

10. The ink jet ink according to claim 1,
wherein the betaine includes trimethyl glycine.

11. The ink jet ink according to claim 1,
wherein a content of the water is 50 to 80 percent by mass with respect to a total mass of the ink.

12. A recording apparatus comprising:
an ink jet head having a nozzle which ejects the ink jet ink according to claim 1 to a recording medium; and
a transport device which transports the recording medium.

13. The recording apparatus according to claim 12,
wherein the ink jet head includes a line head.
